(19) United States
(12) Patent Application Publication
(10) Pub. No.: US 2012/0240415 A1
(43) Pub. Date: Sep. 27, 2012

(54) BLADE FOR A HAIR CLIPPER

(76) Inventors: Richard J. Tringali, Racine, WI (US); Matthew K. Andis, Sturtevant, WI (US); Jeff Gross, Kenosha, WI (US)

(21) Appl. No.: 13/072,046

(22) Filed: Mar. 25, 2011

(51) Int. Cl. B26B 19/04

(52) U.S. Cl. 30/225

(57) ABSTRACT

A hair clipper blade having a mounting portion, a tooth edge, and a plurality of teeth extending from the tooth edge. Each of the plurality of teeth has a left edge, a right edge, and a root, wherein a plane parallel to the right edge of a first tooth of the plurality of teeth and a plane parallel to the left edge of a second tooth of the plurality of teeth form an angle between 0 and 5 degrees, and the plurality of teeth have a tooth pitch between 0.032 and 0.095 inches.

### BACKGROUND

The present invention relates to a blade for a hair clipper, and more particularly to a blade for a hair clipper having a moving cutting blade and a stationary blade.

Hair clippers are known in the art and generally include a bladeset having a stationary blade and a moving blade. The moving blade reciprocates with regard to the stationary blade. Each of the blades has a row of spaced teeth arranged so that hair strands which enter between the teeth of the stationary blade are cut when the teeth of the moving blade pass across the stationary blade teeth.

### SUMMARY

A common drawback of traditional blades for a hair clipper is that the blades do not provide a perfectly straight cut. As the blade is moved through hair, some of the hair falls into the gaps between the teeth of the blade and thus is parallel to the teeth. However, some of the hair must be pushed away from the teeth into the gap between the teeth. The hair that is pushed away from the teeth is not parallel to the teeth. Thus the hair will be cut to different lengths because some of the hair is parallel to the teeth and some of the hair is not parallel to the teeth. Consumers desire that the length of cut hair be the same, also known as an even cut, for aesthetic reasons. An even cut is especially important in competitions such as fairs, dog shows, etc. where animals are judged based on their appearance.

In one embodiment the invention provides a hair clipper blade having a mounting portion, a tooth edge, and a plurality of teeth extending from the tooth edge. Each of the plurality of teeth has a planar left edge, a planar right edge, and a root, wherein a plane parallel to the right edge of a first tooth of the plurality of teeth and a plane parallel to the left edge of a second tooth of the plurality of teeth form an angle between 0 and 5 degrees, and the plurality of teeth have a tooth pitch between 0.032 and 0.095 inches.

In another embodiment the invention provides a metal injection molded blade for use as a stationary blade in a hair clipper. The blade includes a mounting portion, a tooth edge, a plurality of teeth arranged in a spaced, parallel relationship to each other and extending from the tooth edge. Each of the teeth has a tip, a root opposite said tip, a right edge, a left edge and is joined to said tooth edge wherein said plurality of teeth has a tooth pitch between 0.032 and 0.095 inches. In addition at least one of the plurality of teeth has a root narrowing from the tooth edge towards the tip of the at least one of the plurality of teeth. Finally, at least one of the plurality of teeth includes a plane parallel to the right edge of a first tooth of the plurality of teeth and a plane parallel to the left edge of a second tooth of the plurality of teeth forming an angle between 0 and 5 degrees.

Yet another embodiment discloses a hair clipper blade having a mounting portion, a tooth edge, a plurality of teeth extending from the tooth edge and having a tooth pitch P, each of the plurality of teeth having a left edge, a right edge, a tip, and a root. At least one tooth of the plurality of teeth has a height H from the tooth edge at the at least one tooth to the tip of the at least one tooth and a left edge length L from the intersection of the root of the at least one tooth and the left edge of the at least one tooth to the tip of the at least one tooth. The tooth includes a ratio L/P, wherein said left edge length L is divided by said tooth pitch P, of between 6.7 and 8.6.

Other aspects of the invention will become apparent by consideration of the detailed description and accompanying drawings.

### BRIEF DESCRIPTION OF THE DRAWINGS

FIG. 1 is a perspective view of a hair clipper blade.

FIG. 2 is a perspective view of the hair clipper blade of FIG. 1.

FIG. 3. is a front view of the hair clipper blade of FIG. 1.

FIG. 4 is a section view taken along line 4-4 in FIG. 3.

FIG. 5 is an enlarged section view of the hair clipper blade of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

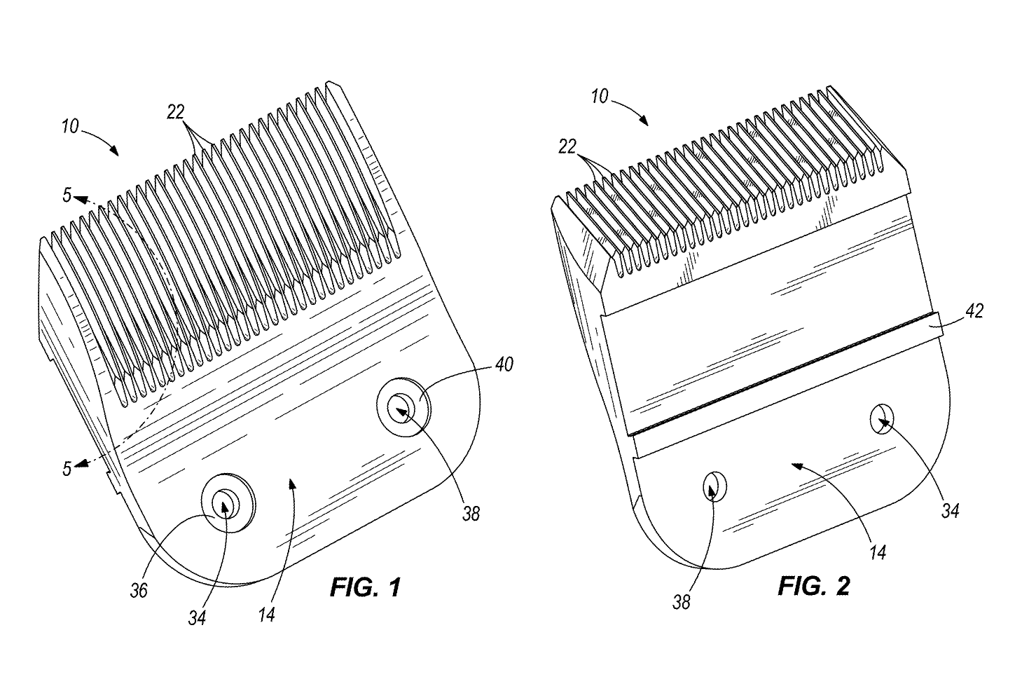

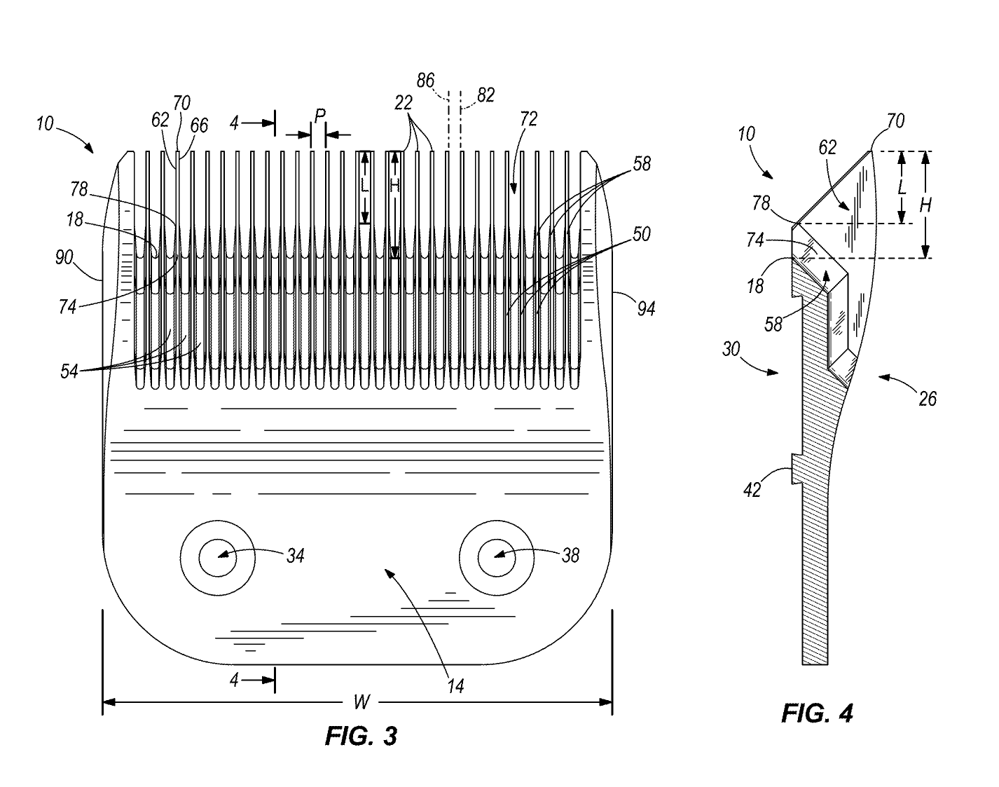

FIG. 1 illustrates a hair clipper blade 10, the blade 10 including a mounting portion 14, a tooth edge 18 (shown in FIG. 3), and a plurality of teeth 22. As seen in FIG. 4, the blade 10 includes a front side 26 and a back side 30. The blade 10 is used with an electric hair clipper or the like having a stationary blade and a moving blade wherein the moving blade is disposed next to the stationary blade and reciprocates relative to the stationary blade.

The mounting portion 14 includes a first and second holes 34, 38, the first hole 34 being surrounded by a first recessed portion 36 on the front side 26, and the second hole 38 being surrounded by a second recessed portion 40 on the front side 26. The first and second holes 34, 38 may receive a screw to fix the blade 10 to an electric hair clipper or the like. A protruding portion 42 is disposed on the back side 30.

The tooth edge 18, best seen in FIG. 3, is disposed proximate to the mounting portion 14. The plurality of teeth 22 extend from the tooth edge 18. A plurality of ribs 50 extend from the tooth edge 18 towards the mounting portion 14, each of the ribs of the plurality of ribs 50 being aligned with each of the teeth of the plurality of teeth 22. In the disclosed embodiment, the plurality of ribs 50 extend to a point approximately half-way between the tooth edge 18 and the first and second holes 34, 38, but other embodiments contemplate longer or shorter ribs 50. A channel 54 is disposed between the ribs 50.

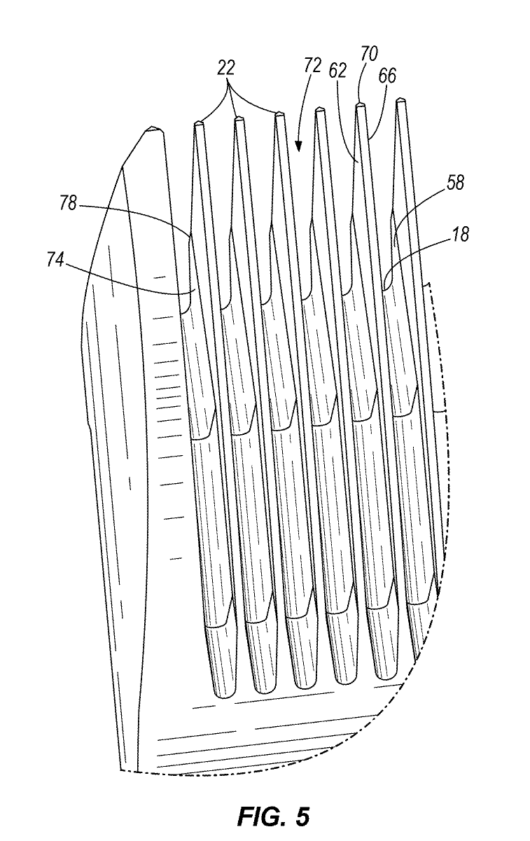

As best seen in FIG. 5, each tooth 22 includes a root 58, a planar left edge 62, a planar right edge 66, and a tip 70. The root 58 is coupled to the tooth edge 18, the root 58 tapering from a broader portion 74 at the tooth edge 18 to a narrow portion 78. The left edge 62 is disposed on the left side of the tooth 22, and extends from the narrow portion 78 to the tip 70. The right edge 66 is disposed on the right side of the tooth 22, and extends from the narrow portion 78 to the tip 70. The tip 70 includes a radius thereon to make the tip 70 dull. An open portion 72 is disposed between the teeth 22, the open portion channeling hair that will be cut towards the tooth edge 18.

A tooth pitch P is defined as the distance between the left edge 62 of two teeth which are disposed next to each other. The blade 10 has a tooth pitch between 0.032 and 0.095 inches. Some embodiments of the blade 10 have a tooth pitch between 0.04 and 0.06 inches. A rake angle R is defined as the angle formed by a first plane 82 parallel to the right edge 66 of a first tooth 22 and a second plane 86 parallel to the left edge 62 of a second tooth 22. If the first plane 82 and second plane 86 are parallel to each other, then the rake angle is 0. The blade 10 has a rake angle between 0 and 5 degrees. The illustrated embodiment of the blade 10 has a rake angle of 0. A length L is defined as the distance between the narrow portion 78 and the tip 70, as seen in FIGS. 3 and 4. In the illustrated embodiment the length L is 0.27 inches, but other embodiments contemplate a shorter or longer length L. A length H is defined as the distance from the tooth edge 18 to the tip 70, as seen in FIGS. 3 and 4. In the illustrated embodiment the length H is 0.40 inches, but other embodiments contemplate a shorter or longer length H. The width W of the hair clipper blade is defined as the distance from a left edge 90 to a right edge 94. The blade 10 has a width W of between 1.6 and 2.1 inches.

The size and arrangement of the teeth 22 allow the blade 10 to evenly cut hair. Prior art blades do not evenly cut hair because the tooth pitch of prior art blades is too large, thus forcing the hair to be bunched in the open spaces between the teeth. When hair is bunched in the open spaces between the teeth, some hair is perfectly parallel to the teeth while other hair is at an angle with regard to the teeth. After being cut, the hair that was at an angle with regard to the teeth will be slightly longer than the hair that was perfectly parallel to the teeth. Prior art blades also have rake angles that further bunch the hair. Barbers, animal groomers, and others who use blades to cut hair must do multiple passes with the blade over the same area to achieve an even cut.

The blade 10 provides an even cut in one pass due to the tooth pitch P and rake angle R. One embodiment of the blade 10 achieves the desired attributes by utilizing the tooth pitch P and rake angle R discussed earlier. Another embodiment of the blade 10 achieves the desired even cut by having a ratio L/P of between 2.9 and 8.6, where the ratio L/P is the length L divided by the tooth pitch P. Other embodiments achieve the desired even cut by having a ratio H/P of between 4.4 and 12.6, where the ratio H/P is the length H divided by the tooth pitch P. Yet other embodiments achieve the desired even cut by having a ratio L/P of between 6.7 and 8.6. Other alternative embodiments achieve the desired even cut by having a ratio H/P of between 8.9 and 12.6.

The blade 10 cannot be manufactured using traditional blade manufacturing techniques. For example, the blade 10 cannot be manufactured using a hob cutter because hob cutters are limited to a rake angle R of at least 5 degrees. The blade 10 cannot be manufactured using a segment cutter because segment cutters cannot cut teeth with a tooth pitch P of less than 0.1 inches. Metal injection molding may be used to manufacture the blade 10 because metal injection molding is able to achieve the necessary tooth pitch P and rake angle R.

Thus, the invention provides, among other things, a hair clipper blade 10. Various features and advantages of the invention are set forth in the following claims.

What is claimed is:

1. A hair clipper blade comprising:
a mounting portion;
a tooth edge; and
a plurality of teeth extending from the tooth edge, each of the plurality of teeth having a planar left edge, a planar right edge, and a root, wherein a plane parallel to the right edge of a first tooth of the plurality of teeth and a plane parallel to the left edge of a second tooth of the plurality of teeth form a rake angle between 0 and 5 degrees, and the plurality of teeth have a tooth pitch between 0.032 and 0.095 inches.

2. The hair clipper blade of claim 1, wherein the plane parallel to the right edge of the first tooth of the plurality of teeth and the plane parallel to the left edge of the second tooth of the plurality of teeth are parallel.

3. The hair clipper blade of claim 1 wherein the plurality of teeth has a tooth pitch between 0.04 and 0.06 inches.

4. The hair clipper blade of claim 3, wherein the plane parallel to the right edge of the first tooth of the plurality of teeth and the plane parallel to the left edge of the second tooth of the plurality of teeth are parallel.

5. The hair clipper blade of claim 4 wherein the hair clipper blade is made of injection molded metal.

6. The hair clipper blade of claim 5 wherein the blade has a width W of between 1.6 and 2.1 inches.

7. A metal injection molded blade for use as a stationary blade in a hair clipper comprising:
a mounting portion;
a tooth edge;
a plurality of teeth arranged in a spaced, parallel relationship to each other and extending from the tooth edge;
each tooth of the plurality of teeth having a tip, a root opposite said tip, a right edge, a left edge and being joined to said tooth edge;
said plurality of teeth having a tooth pitch between 0.032 and 0.095 inches;
wherein at least one of the plurality of teeth has a root narrowing from the tooth edge towards the tip of the at least one of the plurality of teeth; and
wherein a plane parallel to the right edge of a first tooth of the plurality of teeth and a plane parallel to the left edge of a second tooth of the plurality of teeth form an angle between 0 and 5 degrees.

8. The blade of claim 7 wherein the plane parallel to the right edge of the first tooth of the plurality of teeth and the plane parallel to the left edge of the second tooth of the plurality of teeth are parallel.

9. The blade of claim 8 wherein the plurality of teeth has a tooth pitch between 0.04 and 0.06 inches.

10. The blade of claim 7, wherein the plane parallel to the right edge of the first tooth of the plurality of teeth and the plane parallel to the left edge of the second tooth of the plurality of teeth form a rake angle between 1 and 4 degrees.

11. The hair clipper blade of claim 10 wherein the blade has a width W of between 1.6 and 2.1 inches.

12. A hair clipper blade comprising:
a mounting portion;
a tooth edge;
a plurality of teeth extending from the tooth edge and having a tooth pitch P, each of the plurality of teeth having a left edge, a right edge, a tip, and a root;
at least one tooth of the plurality of teeth having a height H from the tooth edge at the at least one tooth to the tip of the at least one tooth;
the at least one tooth of the plurality of teeth having a left edge length L from the intersection of the root of the at least one tooth and the left edge of the at least one tooth to the tip of the at least one tooth;
said left edge length L and said tooth pitch P having a ratio L/P of between 6.7 and 8.6.

13. The hair clipper blade of claim 12 wherein said height H and said tooth pitch P has a ratio H/P of between 8.9 and 12.6.

14. The hair clipper blade of claim 13 wherein a plane parallel to the right edge of a first tooth of the plurality of teeth and a plane parallel to the left edge of a second tooth of the plurality of teeth form an angle between 1 and 4 degrees.

15. The hair clipper blade of claim 13 wherein a plane parallel to the right edge of a first tooth of the plurality of teeth and a plane parallel to the left edge of a second tooth of the plurality of teeth are parallel.

16. The hair clipper blade of claim 15 wherein the plurality of teeth has a tooth pitch between 0.032 and 0.095 inches.

17. The hair clipper blade of claim 16 wherein the plurality of teeth has a tooth pitch between 0.04 and 0.06 inches.

18. The hair clipper blade of claim 17 wherein the blade has a width W of between 1.6 and 2.1 inches.

19. The hair clipper blade of claim 12 wherein the plurality of teeth has a tooth pitch between 0.032 and 0.095 inches.

20. The hair clipper blade of claim 19 wherein the plurality of teeth has a tooth pitch between 0.04 and 0.06 inches.
